(19) United States
(12) Patent Application Publication
(10) Pub. No.: US 2009/0198626 A1
(43) Pub. Date: Aug. 6, 2009

(54) ELECTRONIC AUCTION METHOD

(76) Inventor: Yuriy Petrovich Neshitov, Saint-Petersburg (RU)

Correspondence Address: HOUSTON ELISEEVA, 4 MILITIA DRIVE, SUITE 4, LEXINGTON, MA, 02421, US

(21) Appl. No.: 12/421,901

(22) Filed: Apr. 10, 2009

Related U.S. Application Data
(63) Continuation of application No. PCT/RU2008/000430, filed on Jun. 24, 2008.

(30) Foreign Application Priority Data
Jun. 25, 2007 (RU) 2007124619

(51) Int. Cl. G06Q 30/00

(52) U.S. Cl. 705/80

(57) ABSTRACT

The invention relates to carrying out electronic auctions in a real-time mode. The time-limited rights of physical and/or legal persons, whose rights are based on the international applications for intellectual property protection under the Patent Cooperation Treaty (PCT) filed by said persons in one of the PCT member states, are selected as items for the auction. The use of the inventive method makes it possible to draw the attention of potential buyers to novel technical solutions at early stages of the development thereof, to obtain several lots from one application (up to one hundred or more lots according to the number of PCT member states), to determine the market prices for traded intellectual property rights and to extend the intellectual property market.

### RELATED APPLICATIONS

This application is a Continuation of International Application No. PCT/RU2008/000430, filed on Jun. 24, 2008, which claims priority to Russian Patent Application No. 2007124619, filed on Jun. 25, 2007, both of which are incorporated herein by reference in their entirety.

### FIELD OF THE INVENTION

The present invention concerns ways of carrying out real time electronic auction.

### BACKGROUND OF THE INVENTION

To estimate novelty and technological level (state-of-the-art) of the present invention we will consider a number of technical means of the same use, characterized by the set of similar features. All such devices have been known before the date of a priority of the present invention.

There are known methods and systems of carrying out auctions, that provide carrying out auctions in a mode of real time and include automated workplaces of participants (the Application of Great Britain #2363483, the U.S. Pat. No. 6,161,099, the Application EPB #0987644, Applications PCT WO #01/82191, 02/061664). All these methods and systems are based, however, on carrying out auctions under rigidly set scheme.

The system and method for carrying out auction by means of a computer network under the international Application WO #01/82025 (Nov. 1, 2001) requires the hardware-software complex for the auction, containing, at least, the automated workplace of the leader, the automated workplaces of participants and an auction server with the information base, connected by a communication network to the automated workplace of the leader and to the automated workplaces of participants. This hardware-software complex allows holding the auctions, both with increase, and with fall of the established price. This analogue has rigid scheme of carrying out auction too.

The global automated system of sales based on information network technologies under the patent of the Russian Federation #2222825 includes the block consisting of the information storage block, the block of input, conclusion and representation of the information, the inquiries dispatcher block, blocks of the administrative and information inquiries processing, the database updating block, the reports generator block, the block processing tickets reservation and booking inquiries, the compiler of inquiries of global distributive systems block, the driver of global distributive systems block, the financial block for financial indicators calculation, the periodic operations dispatcher block and the information interchange with global distributive system block.

There is known the method of carrying out electronic auctions with use of the basic auction structure including a trading platform with information base, system of communications and system of payments which runs license contracts trading, as well as the license contracts trade method, allowing companies, wishing to obtain the license for intellectual property to establish the price at an electronic auction in the limits of in advance established trading periods and to establish the price of license contracts by the bids increasing (the Application of the USA #20070061249 from Sep. 14, 2005).

The set of features of the latter Application is close to the set of essential features of the claimed method, therefore this technical decision has been chosen as a Prototype of the present invention.

A disadvantage of the Prototype is that the object of this auction trading is a license contract including transfer of rights on the already valid inventions security documents, the industrial samples, useful models, trade marks, and other objects of intellectual property (IP). The Prototype limits number of IP Sellers to proprietors of the rights on already granted IP, and does not include in the Sellers number the owners of Applications for security documents, who possess certain rights on claimed, but not registered yet IP, namely the rights to be granted with patents under national Applications, and the rights to be granted with patents under the international Applications submitted on the international Patent Cooperation Treaty (PCT), in any country supporting PCT. Another disadvantage of the prototyped trade method is the impossibility to involve Buyers, who are ready to invest in perspective IP before the final registration of security documents. As a result the considerable part of potential IP does not receive appropriate registration (by Buyers) and considerable volume of IP representing commercial interest locates out of trading platforms.

### SUMMARY OF THE INVENTION

The present invention makes it possible to draw attention of potential Buyers and investors to technical novelties at the earliest stages of their elaboration when their owners act in a role of Applicants for the patents, and have only rights on reception of patents under their Applications, not patents it selves. The claimed method solves a problem of satisfying the interests of potential IP Sellers and Buyers and helps to minimize transaction costs. Firstly, through drawing Buyers resources to using a novelty, an opportunity emerges for subsequent patenting of this invention by the Buyer, including inventions with higher degree of risk (risk of non-use of the patent, risk of market failure of technology, etc.). Secondly, due to decrease of transaction costs, an opportunity emerges to involve in economic circulation the price-restricted inventions that could not be used earlier because of high, in comparison with the price of these patents, transacting costs (travel, legal and other expenses) of such patent dealing. Thus, the claimed method can increase and make wider market of the protected IP and support more active involving IP in economic circulation.

According to the WIPO, the parity of the applications submitted by residents and non-residents in 2004 was 1:0.6 (about one million and six hundred thousand accordingly). It means that one application submitted by resident met only 0.6 application submitted out of the resident country. As the PCT today includes more than one hundred countries, the disproportion between actual and theoretically possible situation in patenting in the PCT countries is obvious. As a reasonable explanation of existing low level of foreign (non-resident) patenting is that the money and time expenses for patenting their applications are an absolute obstacle for many Applicants to get patents at national level in other countries, as well as expenses for monitoring possible infringements of the rights and their protection abroad. Resource restriction does not allow many Applicants to extend their rights across boundaries of their countries in the time established by the PCT rules. As a result, after a conventional priority has finished the rights of Applicants are lost.

The claimed invention allows using well-known advantages that the online auctions have in comparison with traditional trade (absence of geographical and time restrictions, low transaction costs) for dealing with such specific objects of trade as the rights to reception of IP patents, particularly to establish fair price that would be recognized by Sellers as well as Users of the invention.

The essence of the present Invention as a technical decision is expressed in the following set of essential features, sufficient for achievement of the technical result specified above:

The Method of carrying out electronic auction with use of the basic auction structure including a trading platform with inquiries and offers information bases; system of communications; system of payments, consisting, in particular, in gathering, processing and representation of the information on conditions of acquisition of the object exposed on auction, and being unique in that as the object of auction the rights physical and/or the legal bodies are chosen, that base on submitted in one of the countries entering into the Patent Cooperation Treaty (PCT), national and/or international applications PCT for delivery of security documents for objects of intellectual property (IP), including inventions, useful models, industrial samples, trade marks, etc. Thus for the chosen national applications, date of close of auction establishes within a year from date of a priority of the Application, and for chosen international Applications PCT date of close of auction establishes within 30 months from date of a priority of the Application. Then the chosen objects expose on auction in defined format of presentation as items on each of the countries, chosen by the Seller from among the countries PCT, and with the initial prices established by the Seller. Thus one Application can be exposed to hundred and more items depending on number of the countries PCT chosen by the Seller, and auction payments differentiate depending on Application and country of origin or the group of the countries planned to transfer of patent rights, thus open the information on the object exposed at auction and a course of the auctions to all potential Buyers and interested persons, carry out transactions under the prices defined in the course of auction trade by increase of bids, thus basic auction structure is supplemented with the consulting block, to providing Buyers in case of need rendering of technical, marketing and legal consulting services, and also the presentation block, to providing Sellers presentation services (connected with their Applications).

That is the set of essential features providing achievement of technical result in all cases on which the claimed volume of the patent protection extends.

Besides, the claimed invention is characterized by a number of facultative features, namely:
the minimal format of information representation on auction is established as the abstract of the Application submitted in one of the countries, entering into PCT, and identity of the abstract is established by the operator of auction;
the minimal format of the information representation on auction is supplemented with the IP description to the Application in language of the country of primary giving or in one of the auction working languages;
the set forth above formats of the information representation on auction are supplemented with multimedia presentation of the item;
as parameters of differentiation of auction payments (fee for listing) for each chosen invention are established, in particular, priority date, the country of application, the country of prospective foreign patenting, technical area;
the consulting block carry out a kind of the branched out international network of the professionals authorized by the auction from among patent attorneys, technological experts, investment experts, experts in the economic right and technological brokers.

The applicant of present invention has not revealed the sources containing the information on technical decisions that sets of features coincide with the set of distinctive features of the claimed invention that allows coming to conclusion of its conformity to a condition “novelty”.

Separate distinctive features of the present invention, such as exhibiting of license contracts to auction and delivering this information to potential buyers, are known from technical level (state-of-the-art), however the applicant does not know any publications which would contain data about influence of the given distinctive signs of the present invention on reached technical result which consists in the choice of specific object of auction, namely the rights of the Applicant (Seller) to reception of patents, possibility of investment in inventions at the earliest stages of their elaboration through timely foreign patenting, and possibility of subsequent commercial use of the invention in the expanded geographical area is provided.

Stated descriptions, according to the Applicant, allows to draw a conclusion on conformity (accordance, meeting) of the claimed invention to a condition “state-of-the-art”.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 presents the scheme of carrying out of electronic auction, and

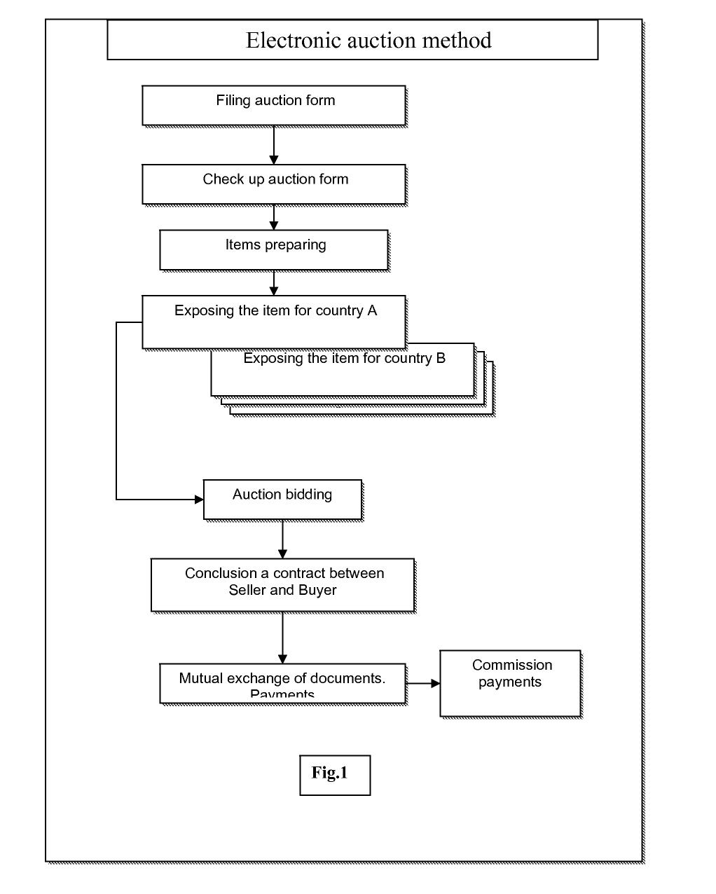

FIG. 2 shows the base structure and the organization of information flows of auction.

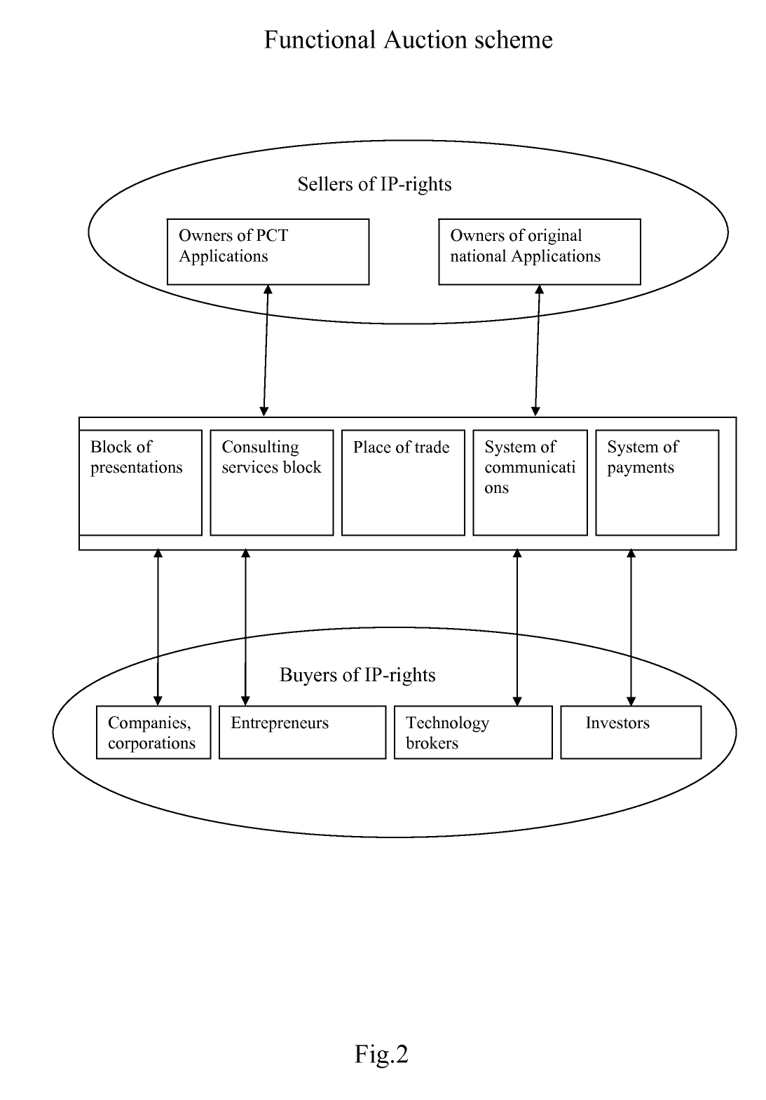

### DETAILED DESCRIPTION OF THE PREFERRED EMBODIMENTS

The method realizes as follows:

The Seller (the Applicant of international PCT application for IP patent (that is the invention, useful model, the industrial sample, a trade mark, etc.) sends to the operator of auction the reference about participation in auction, sends the abstract of the Application and the additional information (depending on a desirable format of presentation) and specifies (list) of the countries where he would like to sell the right to reception of security documents, thus pays the fee differentiated on the countries for listing. If the Seller wants, he addresses the presentation block of auction for presentation manufacturing (including multimedia), visually portraying maintenance IP and its commercial potential. The content and style of presentation IP-items are very important, because are able to attract to the auction potential Buyers for which the clear and popular-manner additional information about the invention and its commercial value is necessary.

The operator of auction checks up reliability of the received information, and, in case of positive result, makes the decision on exhibiting of items according the Application sent.

The item includes, in particular, the minimum format of representation IP as abstract of the international Application which can be added by the expanded presentations given IP, instructions on the country or group of the countries the rights to patenting in which are on sale, the initial price of an item, a termination date of the auctions and the technical details of their carrying out defined by regulations of auction. The information about the exposed items is addressed potential Buyers whom are:
the manufacturers interested in use given IP or in that it was not used by competitors;
the entrepreneurs, ready to launch new business on base of these IP;
the technological brokers counting subsequently on resale of the registered national patent on given IP in the separate country or group of the countries;
the investors reducing patent risks (there are risks of non-use of the patent because of occurrence of more perfect technology or the marketing policy of the competitor, risks expensive proceedings with a high share of uncertainty of result, etc.) by creation of a patent portfolio included items from several Applications that at their subsequent sales (use) will provide comprehensible profitability and admissible risks from the point of view of the investor.

On each country or the group of the countries chosen by the Seller, there is a process of the auctions bidding of exposed items according to the accepted regulations of auction.

Results of the auctions include contracts between the Seller and Buyers about a transfer of the rights to reception of security documents on IP in those countries on which the auctions have passed and have successfully come to the end. Then there are a reception commission's payment and the conclusion of contracts on a transfer of the rights.

By inquiries of Sellers and Buyers, the consulting block of auction provides them with additional services in technology estimation, and also the marketing and legal consultations having essential importance for the conclusion of the transaction on a transfer of the rights.

Then there is a remittance to the Seller and mutual exchange of the contracts signed by the Seller to Buyers. Simultaneously there is a transfer of commission fee to the auction. The claimed method can be realized with use of known techniques and means that causes, according to the applicant of present invention, its conformity to criterion “industrial applicability”.

Use of the declared method allows to achieve such advantages as (in comparison with known technologies):
attraction of attention of potential Buyers to new technical decisions at earliest stages of elaboration of these novelties:
minimization transaction expenses at the conclusion of deals with the IP rights;
possibility to make several items (to hundred and more within number of the countries-participants PCT) from one Application;
potential increase in quantity of the transactions, connected with increase in number of items, with the presentations opening potential traded IP, with consulting services of technical, marketing and legal character, on the one hand, and with maintenance of wide access of potential Buyers to the auction—with another;
establishing of “reasonable” prices for the traded rights on IP (these prices can serve as additional indicators of trends of the technological market);
increase in total amount of IP objects, and volume of the IP market due to registration IP rights by Buyers, and involving of the registered IP in legal economic circulation.

While this invention has been particularly shown and described with references to preferred embodiments thereof, it will be understood by those skilled in the art that various changes in form and details may be made therein without departing from the scope of the invention encompassed by the appended claims.

What is claimed is:

1. The method of carrying out electronic auction with use of the basic auction structure including a trading platform with information bases, system of communications, and system of the payments, consisting, in particular, in gathering, processing and representation of the information about conditions of acquisition of the object exposed on auction, different that as the objects of auction (items) the IP rights of individuals and/or the legal bodies are chosen, based on submitted them in one of the countries entering into the Patent Cooperation Treaty (PCT), the international Application PCT for reception of security documents for IP objects, including inventions, useful models, industrial samples, trade marks, etc., thus an auction date closed establish within 30 months from date of a priority of each Application, then expose on auction the items based on this application, in advance set format of representation on the countries chosen by Sellers from among the countries PCT, and with the initial prices established Sellers, thus open the information about items exposed at auction, and a course (nm) of the auctions to all potential Buyers and interested persons, carry out transactions under the prices defined in the course of auction trade by increase of bids, thus basic auction structure is supplemented with the consulting block, to providing Buyers, if they need, providing of technical, marketing and legal consulting services, and also the presentation block, to providing Sellers with presentation services of their items.

2. The method under point 1, different that the auction establishes the minimum format of presentation of the information as the abstract of the Application submitted in one of the countries entering into PCT, and reliability of the submitted information is checked by the operator of auction.

3. The method under point 1, different that the minimum format of representation of the information is supplement with translation of the abstract of the Application in one of working languages of auction.

4. The method under point 3, different that the minimum format is supplemented with description the Application in language of the country of primary Application or one of auction working languages.

5. The method under point 1, different that the minimum format of presentation of the information is supplemented with multimedia presentation of the

6. The method under point 1, different that as parameters of differentiation of auction payments under each chosen invention establish, in particular, priority date, the country of application, the country of prospective foreign patenting, technical area.

7. The method under point 1, different that the consulting block is carried out a kind of the branched out international network of the professionals included patent attorneys, technological experts, investment experts, lawyers, and technological brokers authorized by the auction.

8. The method under point 1, different that, as objects of the auction (items) the rights of physical and/or the legal bodies are chosen, based on submitted them in one of the countries entering into the PCT, national Applications for security documents for objects of intellectual property (IP), including inventions, useful models, industrial samples, trade marks, etc.
